(19) United States
(12) Patent Application Publication
(10) Pub. No.: US 2026/0048778 A1
(43) Pub. Date: Feb. 19, 2026

(54) Utility Cart Device

(71) Applicant: Gerardo Perez, Elgin, TX (US)

(72) Inventor: Gerardo Perez, Elgin, TX (US)

(21) Appl. No.: 18/943,142

(22) Filed: Nov. 11, 2024

Related U.S. Application Data
(60) Provisional application No. 63/682,366, filed on Aug. 13, 2024.

(51) Int. Cl. B62B 3/10; B62B 3/00; B62B 5/00; B62B 5/06

(52) U.S. Cl. CPC B62B 3/10; B62B 3/005; B62B 5/0079; B62B 5/06; B62B 2301/044; B62B 2301/25

(57) ABSTRACT

A utility cart device is disclosed which is capable of transporting heavy objects. The utility cart comprises a base component that is configured in a rectangular shape with a set of handle bars and a pneumatic tire positioned at each corner. Chucks are provided to keep the device in place. The base component has an open central area sized to retain a large ice chest/cooler and two side, shelf-like areas for retaining additional items. Users load the device and push it with the handle bars, or pull it via securing a cable into the two, spaced-apart D-rings on the front of the device, or tow it via a riding mower, golf cart, ATV or other UTV's with a hitch.

### CROSS-REFERENCE TO RELATED APPLICATION

The present application claims priority to, and the benefit of, U.S. Provisional Application No. 63/682,366, which was filed on Aug. 13, 2024, and is incorporated herein by reference in its entirety.

### FIELD OF THE INVENTION

The present invention relates generally to the field of utility cart devices. More specifically, the present invention relates to an ergonomic utility cart for transporting coolers, chairs, and numerous other heavy items to and from different locations like campsites, beach areas, tailgates, and etc. Accordingly, the present disclosure makes specific reference thereto. Nonetheless, it is to be appreciated that aspects of the present invention are also equally applicable to other like applications, devices and methods of manufacture.

### BACKGROUND

By way of background, this invention relates to improvements in utility cart devices. Generally, people who own large ice chests and coolers may have trouble transporting them to tailgates, campsites, beach areas, and various other outdoor locations and social events. These chests often require multiple people to carry them and multiple trips to carry additional items to and from outdoor locations. Accordingly, after transporting multiple heavy items, people are often fatigued and cannot enjoy their event(s).

Further, moving the large chest across uneven terrain can also be difficult, as the wheels on the ice chest (if any) are typically small and inadequate for moving on the rough terrain. Further, using standard wagons or carts can be dangerous if trying to transport heavy objects over uneven and rough terrain. Additionally, standard wagons and other pull carts may not be able to accommodate large ice chests due to their size and weight. Accordingly, users may have no other means for transporting large ice chests and additional items such as chairs, other than by carrying them.

Accordingly, there is a demand for an improved utility cart device that allows users to transport ice chests and coolers, chairs and other heavy items to and from different locations with case. More particularly, there is a demand for a utility cart device that allows users to easily maneuver oversized objects like cooler and ice chests over all types of rough and uneven terrain.

Therefore, there exists a long felt need in the art for a utility cart device that provides users with an ergonomic utility cart for transporting coolers, chairs and numerous other heavy items to and from different locations like campsites, beach areas, tailgates, etc. There is also a long felt need in the art for a utility cart device that enables men, women, and teenagers to easily maneuver oversized objects like coolers and ice chests over all types of rough and uneven terrain. Further, there is a long felt need in the art for a utility cart device that features an open central area to support a large cooler and two side shelf-like areas that hold additional items and accessories for transport. Moreover, there is a long felt need in the art for a device that allows users to transport the cart by pushing handlebars, utilizing a puling cable, or by using utility vehicles like a golf cart or ATV. Further, there is a long felt need in the art for a utility cart device that offers a much more convenient option for transporting items to different outdoor social events. Finally, there is a long felt need in the art for a utility cart device that can be constructed of aluminum or carbon fiber.

The subject matter disclosed and claimed herein, in one embodiment thereof, comprises a utility cart device. The device is a convenient utility cart capable of transporting heavy objects via various methods. The utility cart device comprises a base component that is configured in a rectangular shape with a set of handle bars and a pneumatic tire positioned at each corner. Chucks are provided to keep the device in place. The base component has an open central area sized to retain a large ice chest/cooler and two side, shelf-like areas for retaining additional items. Users load the device and push it with the handle bars built into the back of the device. Further, there are two, spaced-apart D-rings on the front of the device for receiving a 6-foot cable that allows users to pull the device while another pushes from behind via the handle bars. Furthermore, there is also a larger D-ring attached to the front of the device in the middle, that accommodates a turnbuckle for attaching the device to a riding mower, golf cart, ATV or other UTV's with a hitch to pull it.

In this manner, the utility cart device of the present invention accomplishes all of the forgoing objectives and provides users with a device that transports cooler, chairs, etc., with case. The device is a utility cart that can secure a cooler and additional items for transport. The device can be manufactured of aluminum or carbon fiber materials.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a utility cart device. The device is a convenient utility cart capable of transporting heavy objects via various methods. The utility cart device comprises a base component with a plurality of wheels and a set of handle bars. The base component has an open central area sized to retain a large ice chest/cooler and two side, shelf-like areas for retaining additional items. Users load the device and push it with the handle bars, pull it via a cable, or tow it via a UTV with a hitch.

In one embodiment, the utility cart device provides users with an ergonomic utility cart for transporting coolers, ice chests, chairs, etc. Specifically, the utility cart device enables men, women, and teenagers to easily maneuver oversized objects like coolers and ice chests over all types of rough and uneven terrain. Accordingly, the device can be used at home, on the farm or ranch, or on any type of job site. Thus, the device offers a much more convenient option for transporting items to different outdoor social events.

In one embodiment, the utility cart device is configured to retain a conventional cooler or ice chest, along with other objects, such as chairs, tables, food, drinks, etc. Specifically, the cooler and ice chest is a typical cooler and ice chest as is known in the art. Typically, the cooler and ice chest is a generally rectangular assembly that holds items to be cooled therein with a releasable enclosure lid member.

In one embodiment, the utility cart device comprises a base component that is configured in a rectangular shape. The base component comprises a bottom side, a top side, and opposing sides. The base component comprises an open central area which is sized and shaped to support a large conventional cooler or ice chest. Further, the base component can be available in a variety of sizes to accept various sizes of ice chests or coolers.

In one embodiment, the base component comprises two side, shelf-like areas for retaining additional items, such as chairs, tables, food, drinks, etc. Each shelf-like area comprises a bottom, opposing side walls, and opposing front and back walls, which form a well or channel for retaining additional items. In one embodiment, one of the shelf-like areas comprise a high side wall which extends upward from the base component. The high side wall comprises hooks and straps to secure chairs or tables or other long objects to the side wall, retaining them within the base component.

In one embodiment, the utility cart device comprises four pneumatic tires. Specifically, a pneumatic tire is positioned at each corner of the bottom side of the base component. Typically, the device comprises a support tire assembly which includes a pair of spaced, parallel tires interconnected by a main support shaft. The support shaft is secured to an underside of the bottom side of the base component, one at a front and one at a back of the base component, and rotatable via bearing members (not shown) in a conventional manner. The set of tires can be secured to the support shaft via any suitable securing means as is known in the art, such as bolts, screws, pins, etc. Further, any suitable tires can be utilized as is known in the art, but typically, the tires are rugged, all-terrain wheels which are approximately 2-10 inches in size and which swivel to help the device travel around rough terrain during use. Additionally, any suitable number of tires and any suitable size of tires can be utilized as is known in the art, depending on the needs and/or wants of a user. In one embodiment, the tires are castors, rollers, swivel wheels, etc. disposed on the underside of the bottom side of the base component and may allow the utility cart device to roll in any direction. In other words, the tires may rotate, swivel, and pivot, based on a user's preferences and/or needs.

In one embodiment, the device can include at least one set of chucks. The chucks are conventional chucks which include two wedge-shaped boards held together by a small chain at one end. The wedge-shaped boards are placed one in front of and one behind a set of wheels. Once in position, the device is held in place via the chucks and kept from moving.

In one embodiment, the utility cart device comprises a set of handle bars. The set of handle bars are secured to a back of the base component. The set of handle bars include a set of uprights that the handle bars secure to. Thus, the set of handle bars are positioned at a height above the base component, allowing a user to push the device via the handle bars when moving the device from place to place. The handle bars are secured to the base component via any suitable securing means as is known in the art, such as welding, adhesives, mechanical fasteners, etc. Further, the handle bars can be any suitable size and shape as is known in the art, as long as the handle bars allow a user to securely and comfortably retain the handle bars within their hands. Further, the length and diameter of the handle bars may vary widely, as it is important only that it be reasonably comfortable to hold by hand during use.

In one embodiment, the handle bars can comprise gripping texture areas or other suitable non-slip resistant areas to provide a non-slip grip for a user. Additionally, the handle bars can also be curved or rounded, or otherwise ergonomically shaped to allow the user to more easily push the device, when in use.

In one embodiment, the utility cart device comprises two, spaced-apart D-rings on the front of the device. The D-rings are secured via nails, pins, screws, etc., or any other suitable securing means as is known in the art. The D-rings are sized and shaped to accept a 6-foot cable, or other suitable size cable. Once the cable is inserted through the D-rings, a user can grasp the cable to pull the device. Further, the D-rings can be used in conjunction with the set of handle bars, such that the cable allows users to pull the device, while another user pushes from behind via the set of handle bars.

In one embodiment, the utility cart device comprises a larger D-ring attached to the front of the device, in the middle of the smaller, spaced-apart D-rings. This D-ring is also secured via nails, pins, screws, etc., or any other suitable securing means as is known in the art. This larger, D-ring is sized and shaped to accommodate a turnbuckle or other similar securing means. The turnbuckle allows for attaching the utility cart device to a riding mower, golf cart, ATV or other UTV's with a hitch. Once secured to the UTV hitch, a user can easily pull the utility cart device via the motorized UTV.

In operation, a cooler or ice chest is positioned within the open central area of the base component for transport. Further, chairs, tables, food, drinks, etc., are positioned within the side, shelf-like areas and secured in place via straps, if needed. Wheels secured to an underside of the base component, allow the device to move. A user then pushes the device via the set of handlebars. Further, the device comprises a set of D-rings which accept a cable. The cable allows a user to pull the device, while another user is pushing the device, to lighten the load. A larger D-ring is also secured to the device. This D-ring accommodates a turnbuckle, which then attaches to a UTV hitch, allowing a user to pull the utility cart device via the motorized UTV. Accordingly, this uniquely designed utility cart device can be used at home, on the farm or ranch, or on any type of job site.

In one embodiment, the utility cart device is manufactured from aluminum or carbon fiber, or other suitable materials as is known in the art, or a combination of such materials.

In yet another embodiment, the utility cart device comprises a plurality of indicia.

In yet another embodiment, a method of transporting a cooler and additional objects with ease is disclosed. The method includes the steps of providing a utility cart device comprising a rectangular base component with wheels and a set of handle bars. The method also comprises positioning the cooler within the base component. Further, the method comprises positioning other objects into the side, shelf-like areas of the base component, such as chairs. The method also comprises pushing the device via the handle bars, pulling via a cable, or towing via a UTV. Finally, the method comprises inserting chucks around the wheels to keep the device in place.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIGS. 1A-B illustrate a perspective view of one embodiment of the utility cart device of the present invention showing the device available in different sizes in accordance with the disclosed architecture;

FIGS. 2A-B illustrate a perspective view of one embodiment of the utility cart device of the present invention showing the wheels and the chucks of the device in accordance with the disclosed architecture;

FIG. 3 illustrates a perspective view of one embodiment of the utility cart device of the present invention showing how the device supports a cooler on the base component in accordance with the disclosed architecture;

FIG. 4 illustrates a perspective view of one embodiment of the utility cart device of the present invention showing a side, shelf-like area in accordance with the disclosed architecture;

FIG. 5 illustrates a perspective view of one embodiment of the utility cart device of the present invention showing the device in use in accordance with the disclosed architecture; and

FIG. 6 illustrates a flowchart showing the method of transporting a cooler and additional objects with ease in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a utility cart device that provides users with an ergonomic utility cart for transporting coolers, chairs and numerous other heavy items to and from different locations like campsites, beach areas, tailgates, etc. There is also a long felt need in the art for a utility cart device that enables men, women, and teenagers to easily maneuver oversized objects like coolers and ice chests over all types of rough and uneven terrain. Further, there is a long felt need in the art for a utility cart device that features an open central area to support a large cooler and two side shelf-like areas that hold additional items and accessories for transport. Moreover, there is a long felt need in the art for a device that allows users to transport the cart by pushing handlebars, utilizing a puling cable, or by using utility vehicles like a golf cart or ATV. Further, there is a long felt need in the art for a utility cart device that offers a much more convenient option for transporting items to different outdoor social events. Finally, there is a long felt need in the art for a utility cart device that can be constructed of aluminum or carbon fiber.

The present invention, in one exemplary embodiment, is a novel utility cart device. The utility cart device comprises a base component that is configured in a rectangular shape with a set of handle bars and a pneumatic tire positioned at each corner. Chucks are provided to keep the device in place. The base component has an open central area sized to retain a large ice chest/cooler and two side, shelf-like areas for retaining additional items. Users load the device and push it with the handle bars built into the back of the device. Further, there are two, spaced-apart D-rings on the front of the device for receiving a 6-foot cable that allows users to pull the device while another pushes from behind via the handle bars. Furthermore, there is also a larger D-ring attached to the front of the device in the middle, that accommodates a turnbuckle for attaching the device to a riding mower, golf cart, ATV or other UTV's with a hitch to pull it. The present invention also includes a novel method of transporting a cooler and additional objects with case. The method includes the steps of providing a utility cart device comprising a rectangular base component with wheels and a set of handle bars. The method also comprises positioning the cooler within the base component. Further, the method comprises positioning other objects into the side, shelf-like areas of the base component, such as chairs. The method also comprises pushing the device via the handle bars, pulling via a cable, or towing via a UTV. Finally, the method comprises inserting chucks around the wheels to keep the device in place.

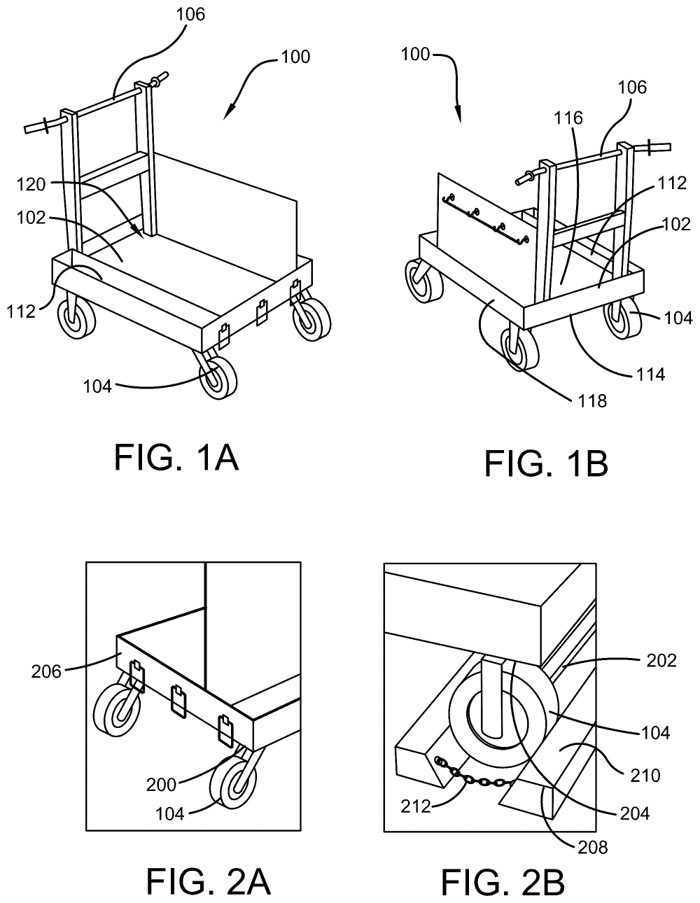

Referring initially to the drawings, FIGS. 1A-B illustrate a perspective view of one embodiment of the utility cart device 100 of the present invention. In the present embodiment, the utility cart device 100 is an improved utility cart device 100 that provides a user with a utility cart capable of transporting a large ice chest or cooler and additional objects with ease. Specifically, the utility cart device 100 comprises a base component 102 with wheels 104 and a set of handle bars 106. Once a cooler 108 is fitted within the base component 102, additional objects 110 can be positioned within the side, shelf-like areas 112. The handle bars 106 allows a user to push the device 100, cooler 108, and additional objects 110 along rough terrain with case.

Generally, the utility cart device 100 provides users with an ergonomic utility cart for transporting coolers 108, ice chests, chairs, etc. Specifically, the utility cart device 100 enables men, women, and teenagers to easily maneuver oversized objects like coolers 108 and ice chests over all types of rough and uneven terrain. Accordingly, the device 100 can be used at home, on the farm or ranch, or on any type of job site. Thus, the device 100 offers a much more convenient option for transporting items 110 to different outdoor social events.

Further, the utility cart device 100 is configured to retain a conventional cooler 108 or ice chest, along with other objects 110, such as chairs, tables, food, drinks, etc. Specifically, the cooler 108 and ice chest is a typical cooler 108 and ice chest as is known in the art. Typically, the cooler 108 and ice chest is a generally rectangular assembly that holds items to be cooled therein with a releasable enclosure lid member.

Additionally, the utility cart device 100 comprises a base component 102 that is configured in a rectangular shape. The base component 102 comprises a bottom side 114, a top side 116, and opposing sides 118. The base component 102 comprises an open central area 120 which is sized and shaped to support a large conventional cooler 108 or ice chest. Further, the base component 102 can be available in a variety of sizes to accept various sizes of ice chests or coolers 108.

As shown in FIGS. 2A-B, the utility cart device 100 comprises four pneumatic tires 104. Specifically, a pneumatic tire 104 is positioned at each corner 200 of the bottom side 114 of the base component 102. Typically, the device 100 comprises a support tire assembly which includes a pair of spaced, parallel tires 104 interconnected by a main support shaft 202. The support shaft 202 is secured to an underside of the bottom side 114 of the base component 102, one at a front 204 and one at a back 206 of the base component 102, and rotatable via bearing members (not shown) in a conventional manner. The set of tires 104 can be secured to the support shaft 202 via any suitable securing means as is known in the art, such as bolts, screws, pins, etc. Further, any suitable tires 104 can be utilized as is known in the art, but typically, the tires 104 are rugged, all-terrain wheels which are approximately 2-10 inches in size and which swivel to help the device 100 travel around rough terrain during use. Additionally, any suitable number of tires 104 and any suitable size of tires can be utilized as is known in the art, depending on the needs and/or wants of a user. In one embodiment, the tires 104 are castors, rollers, swivel wheels, etc. disposed on the underside of the bottom side 114 of the base component 102 and may allow the utility cart device 100 to roll in any direction. In other words, the tires 104 may rotate, swivel, and pivot, based on a user's preferences and/or needs.

Further, the device 100 can include at least one set of chucks 208. The chucks 208 are conventional chucks which include two wedge-shaped boards 210 held together by a small chain 212 at one end. The wedge-shaped boards 210 are placed one in front of and one behind a set of wheels 104. Once in position, the device 100 is held in place via the chucks 208 and kept from moving.

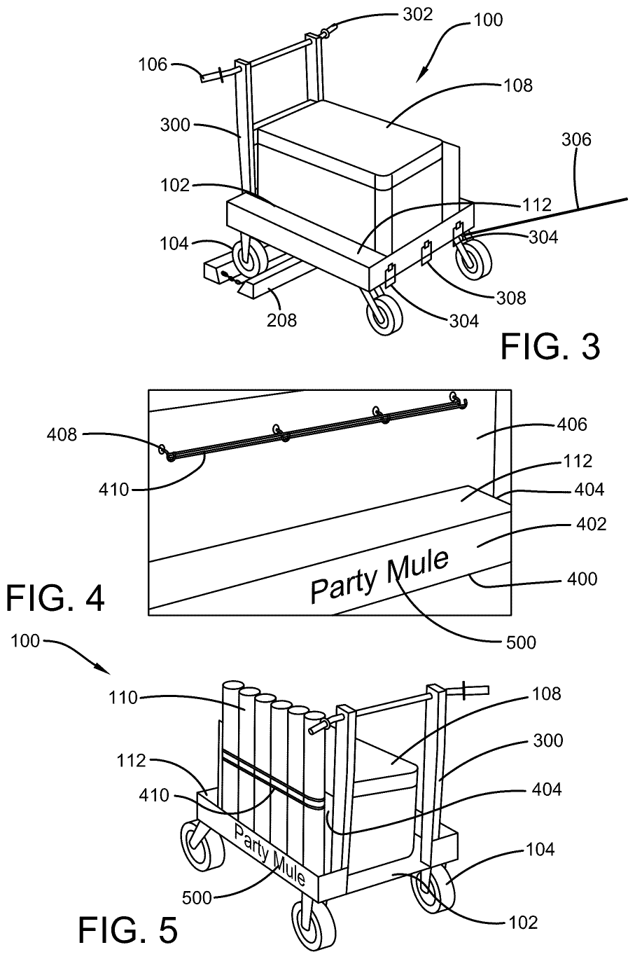

As shown in FIG. 3, the utility cart device 100 comprises a set of handle bars 106. The set of handle bars 106 are secured to a back 206 of the base component 102. The set of handle bars 106 include a set of uprights 300 that the handle bars 106 secure to. Thus, the set of handle bars 106 are positioned at a height above the base component 102, allowing a user to push the device 100 via the handle bars 106 when moving the device 100 from place to place. The handle bars 106 are secured to the base component 102 via any suitable securing means as is known in the art, such as welding, adhesives, mechanical fasteners, etc. Further, the handle bars 106 can be any suitable size and shape as is known in the art, as long as the handle bars 106 allow a user to securely and comfortably retain the handle bars 106 within their hands. Further, the length and diameter of the handle bars 106 may vary widely, as it is important only that it be reasonably comfortable to hold by hand during use.

In one embodiment, the handle bars 106 can comprise gripping texture areas 302 or other suitable non-slip resistant areas to provide a non-slip grip for a user. Additionally, the handle bars 106 can also be curved or rounded, or otherwise ergonomically shaped to allow the user to more easily push the device 100, when in use.

Further, the utility cart device 100 comprises two, spaced-apart D-rings 304 on the front 204 of the device 100. The D-rings 304 are secured via nails, pins, screws, etc., or any other suitable securing means as is known in the art. The D-rings 304 are sized and shaped to accept a 6-foot cable 306, or other suitable size cable 306. Once the cable 306 is inserted through the D-rings 304, a user can grasp the cable 306 to pull the device 100. Further, the D-rings 304 can be used in conjunction with the set of handle bars 106, such that the cable 306 allows users to pull the device 100, while another user pushes from behind via the set of handle bars 106.

Additionally, the utility cart device 100 comprises a larger D-ring 308 attached to the front 204 of the device 100, in the middle of the smaller, spaced-apart D-rings 304. This D-ring 308 is also secured via nails, pins, screws, etc., or any other suitable securing means as is known in the art. This larger, D-ring 308 is sized and shaped to accommodate a turnbuckle (not shown) or other similar securing means. The turnbuckle allows for attaching the utility cart device 100 to a riding mower, golf cart, ATV or other UTV's with a hitch. Once secured to the UTV hitch, a user can easily pull the utility cart device 100 via the motorized UTV.

As shown in FIG. 4, the base component 102 comprises two side, shelf-like areas 112 for retaining additional items 110, such as chairs, tables, food, drinks, etc. Each shelf-like area 112 comprises a bottom 400, opposing side walls 402, and opposing front and back walls 404, which form a well or channel for retaining additional items 110. In one embodiment, one of the shelf-like areas 112 comprise a high side wall 406 which extends upward from the base component 102. The high side wall 406 comprises hooks 408 and straps 410 to secure chairs or tables or other long objects 110 to the high side wall 406, retaining them within the base component 102.

As shown in FIG. 5, in operation, a cooler 108 or ice chest is positioned within the open central area 120 of the base component 102 for transport. Further, chairs, tables, food, drinks, etc., are positioned within the side, shelf-like areas 112 and secured in place via straps 410, if needed. Wheels 104 secured to an underside of the base component 102, allow the device 100 to move. A user then pushes the device 100 via the set of handlebars 106. Further, the device 100 comprises a set of D-rings 304 which accept a cable 306. The cable 306 allows a user to pull the device 100, while another user is pushing the device 100, to lighten the load. A larger D-ring 308 is also secured to the device 100. This D-ring 308 accommodates a turnbuckle, which then attaches to a UTV hitch, allowing a user to pull the utility cart device 100 via the motorized UTV. Accordingly, this uniquely designed utility cart device 100 can be used at home, on the farm or ranch, or on any type of job site.

Generally, the utility cart device 100 is manufactured from aluminum or carbon fiber, or other suitable materials as is known in the art, or a combination of such materials.

In yet another embodiment, the utility cart device 100 comprises a plurality of indicia 500. The base component 102 of the device 100 may include advertising, a trademark, or other letters, designs, or characters, printed, painted, stamped, or integrated into the base component 102, or any other indicia 500 as is known in the art. Specifically, any suitable indicia 500 as is known in the art can be included, such as but not limited to, patterns, logos, emblems, images, symbols, designs, letters, words, characters, animals, advertisements, brands, etc., that may or may not be cooler, ice chest, or brand related.

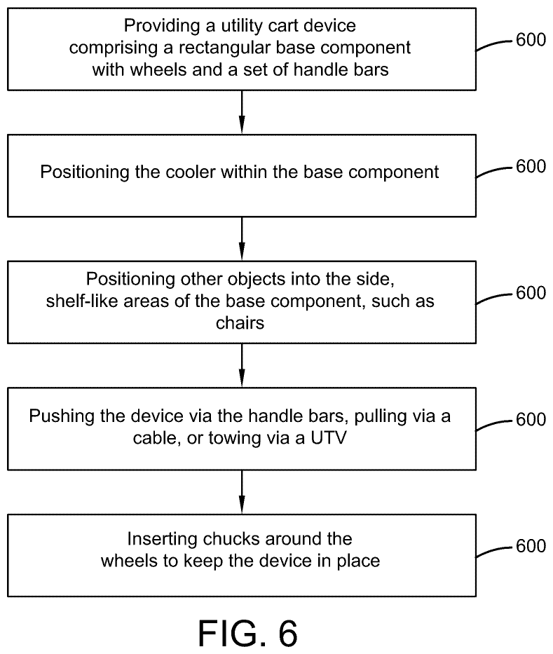

FIG. 6 illustrates a flowchart of the method of transporting a cooler and additional objects with case. The method includes the steps of at 600, providing a utility cart device comprising a rectangular base component with wheels and a set of handle bars. The method also comprises at 602, positioning the cooler within the base component. Further, the method comprises at 604, positioning other objects into the side, shelf-like areas of the base component, such as chairs. The method also comprises at 606, pushing the device via the handle bars, pulling via a cable, or towing via a UTV. Finally, the method comprises at 608, inserting chucks around the wheels to keep the device in place.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “utility cart device” and “device” are interchangeable and refer to the utility cart device 100 of the present invention.

Notwithstanding the forgoing, the utility cart device 100 of the present invention can be of any suitable size and configuration as is known in the art without affecting the overall concept of the invention, provided that it accomplishes the above stated objectives. One of ordinary skill in the art will appreciate that the utility cart device 100 as shown in FIGS. 1-6 is for illustrative purposes only, and that many other sizes and shapes of the utility cart device 100 are well within the scope of the present disclosure. Although the dimensions of the utility cart device 100 are important design parameters for user convenience, the utility cart device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A utility cart device that is capable of transporting multiple objects with ease, the utility cart device comprising:
a base component;
a plurality of tires; and
a set of handle bars; and
wherein the set of handle bars and the plurality of tires are secured to the base component;
wherein the base component is sized and shaped to retain a cooler and additional objects; and
further wherein the set of handle bars allow a user to push the base component along rough terrain with ease.

2. The utility cart device of claim 1, wherein the base component is configured in a rectangular shape, with a bottom side, a top side, and opposing sides.

3. The utility cart device of claim 2, wherein the base component comprises an open central area which is sized and shaped to support a large conventional cooler or ice chest.

4. The utility cart device of claim 3, wherein the base component comprises two side, shelf-like areas for retaining additional items.

5. The utility cart device of claim 4, wherein at least one side, shelf-like area comprises a bottom, opposing front and back walls, a side wall, and an opposing high side which extends upward from the base component and comprises hooks and straps to secure items.

6. The utility cart device of claim 5 wherein the plurality of tires comprise four pneumatic tires, with a pneumatic tire positioned at each corner of the bottom side of the base component.

7. The utility cart device of claim 6, wherein the base component comprises a support tire assembly, secured at a front and one at a back of the base component, which includes a pair of spaced, parallel tires interconnected by a main support shaft, with the support shaft secured to an underside of the bottom side of the base component.

8. The utility cart device of claim 7, wherein the pair of spaced, parallel tires are rugged, all-terrain wheels which are approximately 2-10 inches in size and which swivel to help the utility cart device travel around rough terrain during use.

9. The utility cart device of claim 8, wherein the base component comprises at least one set of chucks, which keep the base component from moving.

10. The utility cart device of claim 9, wherein the set of handle bars are secured to a back of the base component.

11. The utility cart device of claim 10, wherein the set of handle bars include a set of uprights that the set of handle bars are secured to.

12. The utility cart device of claim 11, wherein the base component comprises two, spaced-apart D-rings on the front of the base component.

13. The utility cart device of claim 12, wherein the two, spaced-apart D-rings are sized and shaped to accept a 6-foot cable.

14. The utility cart device of claim 13, wherein a user grasps the 6-foot cable to pull the base component.

15. The utility cart device of claim 14, wherein the base component comprises a large D-ring attached to the front of the base component for accommodating a turnbuckle for attaching the utility cart device to a riding mower, golf cart, ATV or other UTV's with a hitch to be towed.

16. A utility cart device that is capable of transporting multiple objects with ease, the utility cart device comprising:
a base component configured in a rectangular shape, with a bottom side, a top side, and opposing sides;
four pneumatic tires, with a pneumatic tire positioned at each corner of the bottom side of the base component; and
a set of handle bars secured to a back of the base component; and
wherein the base component comprises an open central area which is sized and shaped to support a large conventional cooler or ice chest;
wherein the base component comprises two side, shelf-like areas for retaining additional items, such as chairs or tables;
wherein at least one side, shelf-like area comprises a bottom, opposing front and back walls, a side wall, and an opposing high side which extends upward from the base component and comprises hooks and straps to secure items;
wherein the base component comprises at least one set of chucks, which keep the base component from moving;
wherein the set of handle bars allow a user to push the base component along rough terrain with ease;
wherein the base component comprises two, spaced-apart D-rings on the front of the base component, which are sized and shaped to accept a 6-foot cable used for pulling the base component; and
further wherein the base component comprises a large D-ring attached to the front of the base component for accommodating a turnbuckle for attaching the utility cart device to a riding mower, golf cart, ATV or other UTV's with a hitch to be towed.

17. The utility cart device of claim 16, wherein the utility cart device is manufactured from aluminum or carbon fiber.

18. The utility cart device of claim 16, wherein the set of handle bars comprise a gripping texture area.

19. The utility cart device of claim 16 further comprising a plurality of indicia.

20. A method of transporting a cooler and additional objects with ease, the method comprising the following steps:
providing a utility cart device comprising a rectangular base component with wheels and a set of handle bars;
positioning the cooler within the base component;
positioning other objects into the side, shelf-like areas of the base component, such as chairs;
pushing the device via the handle bars, pulling via a cable, or towing via a UTV; and inserting chucks around the wheels to keep the device in place.
